(19) United States
(12) Patent Application Publication
(10) Pub. No.: US 2024/0400448 A1
(43) Pub. Date: Dec. 5, 2024

(54) MATERIAL COMPOSITION FOR USE IN CONSTRUCTION AND METHODS OF APPLYING THE SAME

(71) Applicant: ONX, INC., Carrollton, TX (US)

(72) Inventor: Mohamed Kassim Jahaber, George Town (MY)

(73) Assignee: ONX, INC., Carrollton, TX (US)

(21) Appl. No.: 18/205,173

(22) Filed: Jun. 2, 2023

(51) Int. Cl. C04B 11/26; C04B 16/04; C04B 22/10; C04B 41/49

(52) U.S. Cl. CPC C04B 11/266; C04B 16/04; C04B 22/10; C04B 41/4961; C04B 2103/20; C04B 2111/00672; C04B 2111/1037

(57) ABSTRACT

A material composition for use in construction includes calcium sulfate hemihydrate (CSH), calcium carbonate (CC) powder, hydrophobic dispersible polymer, and a retarder comprising modified amino acid. Further, a method of using material composition in one or more construction activities includes adding the material composition to water in a mixer, the material composition comprises calcium sulfate hemihydrate (CSH), calcium carbonate (CC) powder, hydrophobic dispersible polymer, and a retarder comprising modified amino acid. The method further includes blending the material composition with water in the mixer for a predetermined amount of time to produce a jointing compound having a predetermined consistency and workability.

### FIELD OF THE INVENTION

The disclosure generally relates to material compositions formulated for architectural applications as jointing compounds as well as methods of using these compositions in construction related activities. In particular, the present disclosure relates to dry, cement-free (green) material compositions that when hydrated produce a jointing compound having high adhesion, low shrinkage, and hydrophobic properties.

### BACKGROUND OF THE INVENTION

Builders of both commercial and non-commercial buildings are constantly looking for new innovative products and materials in order to make buildings more environmentally friendly and energy efficient, to better protect them from the weather, and to make them more aesthetically pleasing, among other like objects.

One building material that is commonly used in construction is a drywall jointing compound. It is generally used for filling, smoothing, and finishing gypsum board drywalls and is also used for repairing minor scratches and dents. However, commercially available jointing compounds are highly water absorbent and are, therefore, strictly used only in interior dry areas of a building. Additionally, these compounds generate dust during the sanding process, which causes eye, skin, and respiratory irritation and is hazardous to construction workers.

Therefore, new and improved jointing compound compositions are needed for use in construction related activities, especially for architectural applications. The present disclosure provides such compositions as well as methods of making and using these compositions in construction activities.

### SUMMARY OF THE INVENTION

The following represents a summary of some embodiments of the present disclosure to provide a basic understanding of various aspects of the disclosed herein. This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below. Embodiments of material compositions and methods for manufacturing and using them in construction to address at least some of the above challenges and issues are disclosed.

In some aspects, the present disclosure is directed to a material composition for use in construction. The material composition includes calcium sulfate hemihydrate (CSH), calcium carbonate (CC) powder, a hydrophobic dispersible polymer, and a retarder comprising modified amino acid.

In some embodiments, the hydrophobic dispersible polymer is based on a flexible terpolymer of vinyl chloride, ethylene, and vinyl laurate.

In some embodiments, amounts of one or more of the CSH, the CC powder, the hydrophobic dispersible polymer, and the retarder correspond to a water absorption rate of the material composition. The water absorption rate corresponds to a ratio of a weight of water absorbed to a weight of the material composition in dry form. Further, in some embodiments, the water absorption rate of the material composition is less than 5%.

In some embodiments, the material composition further includes a silane emulsion coating for application on the surface of the material composition. The silane emulsion coating includes a solventless emulsion based on a mixture of silane and siloxane. Further, in some embodiments, the silane emulsion coating is formulated to reduce a capillary water absorption rate of the material composition. The capillary water absorption rate corresponds to a rate of water absorption into the material composition by capillary suction.

In some embodiments, a grain size of the material composition is 75 um or less.

In some embodiments, the material composition further includes water in an amount such that a flowable consistency of the material composition is within a predetermined range.

In some embodiments, the material composition is cement-free.

In some embodiments, the material composition forms one or more of gypsum board joint filler, interior and exterior ceilings coating, gypsum board lamination, dry and wet interior coating, exterior coating, and a skim coat for concrete, block, and brick wall substrates.

In some embodiments, the material composition includes a quantity of the CSH between 50%-80% of the material composition by weight, a quantity of the CC powder between 20%-50% of the material composition by weight, a quantity of the hydrophobic dispersible polymer between 2%-3% of the material composition by weight, and a quantity of the retarder between 0.01%-0.011% of the material composition by weight.

In some aspects, the present disclosure is directed to a method of using material composition in one or more construction activities. The method includes adding the material composition to water in a mixer, the material composition comprises calcium sulfate hemihydrate (CSH), calcium carbonate (CC) powder, a hydrophobic dispersible polymer, and a retarder comprising modified amino acid, and blending the material composition with water in the mixer for a predetermined amount of time to produce a jointing compound having a predetermined consistency and workability.

In some embodiments, the method further includes applying a coat of a predetermined thickness of the jointing compound to a substrate. In some embodiments, the predetermined thickness is 5 mm or less.

In some embodiments, the method further includes applying a silane emulsion coating on a surface of the jointing compound. The silane emulsion coating includes a solventless emulsion based on a mixture of silane and siloxane. In some embodiments, applying the silane emulsion coating includes mixing a silane emulsion with water in a ratio between 1:4 and 1:9.

In some embodiments, the amounts of one or more of: the CSH, the CC powder, the hydrophobic dispersible polymer, and the retarder correspond to a water absorption rate of the material composition. The water absorption rate corresponds to a ratio of a weight of water absorbed to a weight of the material composition in dry form. In some embodiments, the water absorption rate of the material composition is less than 5%.

In some embodiments, the method further includes applying the jointing compound as one or more of: gypsum board joint filler, interior and exterior ceilings coating, gypsum board lamination, dry and wet interior coating, exterior coating, and a skim coat for concrete, block, and brick wall substrates.

In some embodiments, the method includes adding the material composition to water, the material composition includes a quantity of the CSH between 50%-80% of the material composition by weight, a quantity of the CC powder between 20%-50% of the material composition by weight, a quantity of the hydrophobic dispersible polymer between 2%-3% of the material composition by weight, and a quantity of the retarder between 0.01%-0.011% of the material composition by weight.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element.

FIG. 1 illustrates ingredients collated in the form of a group that make up an exemplary material composition, in accordance with some embodiments of the present disclosure.

FIG. 2 illustrates an arrangement for manufacturing material compositions, in accordance with some embodiments of the present disclosure.

FIG. 3 illustrates the steps of a method for manufacturing and using material compositions for construction activities, in accordance with some embodiments of the present disclosure.

### DETAILED DESCRIPTION

The following detailed description is presented to enable any person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown, but is to be accorded the widest possible scope consistent with the principles and features disclosed herein.

Embodiments of the present disclosure provide new, improved, material compositions, with many advantages in architectural applications, such as quick setting time, low shrinkage, high adhesion, and water repellence. By leveraging such material compositions in building architectures, the present disclosure provides a jointing compound that is multi-functional and can be used in dry and wet areas of a building.

Material compositions in accordance with the embodiments are different from plaster and mortar. This difference is based both on use as well as composition. Preferably, these material compositions include specific forms of calcium sulfate, i.e., calcium sulfate hemihydrate (CSH). Further, in some embodiments these material compositions include calcium carbonate (CC) in a powder form, retarders such as poly condensed amino acids, and hydrophobic dispersible polymer. In some embodiments, the hydrophobic dispersible polymer is based on a flexible terpolymer of vinyl chloride, ethylene, and vinyl laurate. The hydrophobic dispersible polymer provides a hydrophobic effect to the material composition.

Some embodiments provide several other objects and advantages, some of which are discussed below. Material compositions have been specially formulated to have hydrophobic properties. In some embodiments, a water absorption rate of the material composition is less than 5%. Water absorption rate corresponds to a ratio of a weight of water absorbed to a weight of the material composition in dry form. Hence, it can be used in dry and wet areas of a building.

In some embodiments, one advantage of the material compositions in accordance with the present disclosure is that they can be used in exterior areas of a building as well as interior areas. In some embodiments, a silane emulsion coating is applied on the material composition when applied in the exterior area of a building. The silane emulsion coating includes a solventless emulsion based on a mixture of silane and siloxane. In some embodiments, two coats of the silane emulsion is applied on a wet-on-wet basis to achieve a waterproofing effect. Another advantage of the material compositions in accordance with embodiments of the present disclosure is that they generate nearly zero dust during sanding which is an essential step to create a smooth and even surface in preparation for the application of a primer and/or paint. Generally, the process of sanding a jointing compound creates a substantial amount of dust, which may cause several health risks for the construction workers. However, the material composition, in accordance with the disclosed embodiments, includes the hydrophobic dispersible polymer which binds all ingredients of the material composition and improves the bonding of interfaces of the ingredients. Thus, there is a significant dust reduction when the disclosed jointing compound is sanded.

Preferably, material compositions and/or the resulting jointing compounds in accordance with some embodiments are multi-functional, and their applications are not limited to gypsum board or gypsum-based substrates only. These compositions, compounds, or both are suitable for other substrates as well, such as concrete, block, brick, and the like. Further, the material compositions and/or the resulting jointing compounds generate minimal dust during the sanding process, thereby reducing the risk of construction workers' eye, skin, nose, and respiratory irritation. These and other like advantages make the disclosed embodiments more versatile, environmentally friendly, economical, and sustainable.

Certain terms and phrases have been used throughout the disclosure and will have the following meanings in the context of the ongoing disclosure.

“Concrete” for the purposes of the present disclosure may refer to a hard strong building material.

“Cement” for the purposes of the present disclosure may refer to a binder, a substance that sets and hardens and can bind other materials together. Cement is manufactured through a closely controlled chemical combination of calcium, silicon, aluminum, iron, and other ingredients. Common materials used to manufacture cement may include, but are not limited to, limestone, shells, and chalk or marl combined with shale, clay, slate, blast furnace slag, silica sand, and iron ore. Some of the types of cement may include, but are not limited to, hydraulic and elite cements, such as Portland Cement, blended cements, masonry cement, oil well cement, natural cement, alumina cement, expansive cements, and the like, and mixtures thereof.

“Gypsum” for the purposes of the present disclosure may refer to a soft sulfate mineral composed of calcium sulfate. It is widely used as a main constituent in many forms of plaster and drywall. Gypsum board is primarily used as a finish for walls and ceilings. It is also referred to as plasterboard, sheetrock, or drywall in construction applications. Further, gypsum blocks are used similar to concrete blocks in building construction.

“Jointing compound” for the purposes of the present disclosure may refer to a Joint compound (also known as drywall compound, drywall mud, or mastic) is a white powder of primarily gypsum dust mixed with water to form a paste of a desired consistency. The jointing compound has a variety of applications in a construction environment. For example, it may be used with paper or fiber joint tape to seal joints between sheets of drywall to create a seamless base for paint on interior walls and ceilings.

“Calcium sulfate hemihydrate” for the purposes of the present disclosure may refer to the compound CaSO4.½H2O. In the present disclosure, the abbreviation “CSH” refers to calcium sulfate hemihydrate.

“Calcium carbonate” for the purposes of the present disclosure may refer to the compound Ca CO₃. In the present disclosure, the abbreviation “CC” refers to calcium carbonate.

“Polymer” for the purposes of the present disclosure may include, but is not limited to, homopolymers, copolymers, graft copolymers, and blends and combinations thereof.

“Water absorption rate” of a material composition for the purposes of the present disclosure may refer to a ratio of a weight of water absorbed to a weight of the material composition in dry form.

In accordance with some embodiments, the present disclosure is directed to a material composition for use in construction. The material composition may include calcium sulfate hemihydrate (CaSO₄.½H₂O) (CSH), calcium carbonate (Ca CO₃) (CC) powder, hydrophobic dispersible polymer, and a retarder. The retarder may include at least poly condensed amino acid, and the hydrophobic dispersible polymer may include a flexible terpolymer of vinyl chloride, ethylene, and vinyl laurate.

In some embodiments, the material composition may be available in prepacked/prepackaged form, where water is added in an amount to produce a jointing compound having a predetermined consistency and workability. In some embodiments, the material composition of the present disclosure is highly suitable for forming one or more of: gypsum board joint filler, interior and exterior ceilings coating, gypsum board lamination, dry and wet interior coating, exterior coating, and a skim coat for concrete, block, and brick wall substrates.

In some embodiments, amounts of one or more of: the CSH, the CC powder, the hydrophobic dispersible polymer, and the retarder correspond to a water absorption rate of the material composition. As described above, the water absorption rate may correspond to a ratio of a weight of water absorbed to a weight of the material composition in dry form. In some embodiments, the water absorption rate of the material composition is less than 5%. Thus, the material composition in accordance with the present disclosure is hydrophobic in nature.

In some embodiments, the material composition, so disclosed, may be used in one or more construction activities. For such embodiments, the material composition may be added to water in a mixer. In some embodiments, the material composition may be blended in the mixer for a predetermined amount of time at a predetermined speed until a jointing compound having a predetermined consistency and workability is achieved. In an embodiment, the predetermined amount of time and/or the predetermined speed may be based on a type and/or a size of the mixer. In another embodiment, the predetermined amount of time and/or the predetermined speed may be based on the desired consistency of the mixture.

In some embodiments, a specially developed silane emulsion coating may be applied on the surface of the jointing compound. The silane emulsion coating is a water-thinnable, solventless emulsion based on a mixture of silane and siloxane. The silane emulsion coating is prepared by mixing a water re-dispersible silicone-based water repellent powder with water in a ratio between 1:4 and 1:9. The silane emulsion coating is formulated to reduce a capillary water absorption rate of the material composition. In some embodiments, the capillary water absorption rate corresponds to a rate of water absorption into the material composition by capillary suction. Thus, the silane emulsion coating reduces the capillary absorption rate of the material composition but does not clog pores or capillaries. Therefore, it does not affect the jointing compound's ability to breathe.

In another embodiment, the water re-dispersible silicone-based water repellent powder may be added directly to the dry ingredients of the material composition. In this embodiment, the water re-dispersible silicone-based water repellent powder is 0.3%-0.5% of the material composition by weight.

These and other embodiments are discussed in detail below.

In some embodiments, the present disclosure relates to a material composition that includes calcium sulfate hemihydrate (CSH), calcium carbonate (CC) powder, hydrophobic dispersible polymer, and a retarder. Calcium sulfate hemihydrate (CSH) for the purposes of the present disclosure refers to CaSO₄.½H₂O. A person of ordinary skill in the art will understand that calcium sulfate is available in many forms such as, but not limited to, calcium sulfate hemihydrate, anhydrous calcium sulfate, etc.

Preferably, some material compositions in accordance with the embodiments include CSH because of the various advantages that it offers. For example, CSH provides a high increase in gelation and improved final setting times of the resulting concrete mix. In some embodiments, CSH can be obtained from naturally available sources or is produced industrially. A person of ordinary skill in the art will understand that CSH is typically prepared from gypsum. Calcium sulfate hemihydrate for the purposes of the present disclosure refers to CaSO₄.½H₂O. Further, as one example, gypsum which is naturally available in solid form as deposits, undergoes many processes, such as (but not limited to) grinding and heating under high pressure to get the final CaSO₄.½H₂O (CSH) in fine powder form in factories.

In some embodiments, the material composition includes CSH, where CSH is 50%-80% of the material composition by weight. This material acts like a binder and the quality of CSH directly influences the properties such as compressive strength, flexural strength, setting time, durability, etc., of the resulting concrete. CSH may react with other fundamental components of the material composition, as mentioned above, to minimize or eliminate shrinkage cracks while imparting other useful properties to the disclosed material composition. Further, CSH provides higher compressive strengths as compared to other forms of calcium sulfate. Furthermore, use of CSH in the material compositions results in a preferred pH value of approximately 12 in the resulting concrete mix, though other pH values are also contemplated. In some embodiments, a blend of two or more forms of calcium sulfate is used to modify the set times and early compressive strength properties of the material composition as suitable for the building requirements. Early setting time is an intrinsic property of all calcium sulfates and CSHs. CSHs typically lose their plasticity within 10 minutes of being mixed with water. Thus, in some embodiments, CSH may impart longer setting times with the aid of a retarder. The compressive strength of the obtained concrete may be enhanced with CSH. All CSHs are available in the market and are of different types. The pH values of all commercially available CSHs vary. To get optimum results from the present material compositions, CSHs with higher pH values (pH>10) are preferable. In some embodiments, two or more CSHs are blended to obtain the required pH value in a given material composition.

In some embodiments, the material composition includes calcium carbonate (CC) powder, where the CC powder is 20%-50% of the material composition by weight. Calcium carbonate helps accelerate the cure rate of a material composition and helps in increasing the initial setting time of the material composition. The higher the initial setting time of the material composition, the higher the product's workability. Thus, CC powder helps in facilitating a long enough work time with the material composition so that it can level itself and be more easily pushed, molded, and smoothed out.

In some embodiments, the material composition includes a hydrophobic dispersible polymer, where the hydrophobic dispersible polymer is 2%-3% of the material composition by weight. Dispersible polymers may include homopolymer or copolymer dispersions. In some embodiments, the dispersions may be spray-dried to make them free-flowing and storable. Dispersible polymers are added to the material composition to significantly improve their properties. For example, dispersible polymers may affect a material composition's bending tensile strength, abrasion resistance, and compressive strength. In accordance with the present disclosure, specially formulated hydrophobic dispersible polymer is based on a flexible terpolymer of vinyl chloride, ethylene, and vinyl laurate. Further, because of the hydrophobic properties of the polymer, the polymer helps decrease the water content in the material composition and/or the resulting jointing compound. In some embodiments, the amounts of the hydrophobic dispersible polymer, along with one or more of the CSH, CC powder, and the retarder correspond to a water absorption rate of the material composition. In some embodiments, the water absorption rate of the material composition is less than 5%.

Retarder(s) are polymer components that are used in some embodiments of the present material composition. In some embodiments, a recommended percentage of the retarder is 0.01%-0.011% of the material composition by weight. In some embodiments, retarders, such as poly condensed amino acids, are used in the material composition. Such retarders help to slow the hydration process of the material composition. Further, the retarders provide excellent performance on increasing the initial setting time of the material composition. The amounts of the retarders used depend on the type of retarder and can easily be determined by a person skilled in the art, after reading this disclosure, in accordance with the jointing compound requirements. A person of ordinary skill in the art will understand that other scenarios are also possible for the same. In some embodiments, the addition of a retarder can prolong the initial setting time. In one example, the initial setting time is between 45 and 60 minutes, though other times are also contemplated. In some embodiments, the initial setting time is customizable by adjusting the retarder dosage.

In some embodiments, a silane emulsion coating is applied on the surface of the material composition. The silane emulsion coating may be formed by mixing a water re-dispersible silicone-based water repellent powder with water in a ratio between 1:4 and 1:9. The water re-dispersible silicone-based water repellent powder includes a water-redispersible silicone, that is, the water-repellent in powder form is dispersible in water. Additionally, in some embodiments, the water re-dispersible silicone-based water repellent powder is based on highly efficient silicones. The silane emulsion acts as water repellent even at very low concentrations, without affecting the water vapor permeability of the material composition, that is, the silane emulsion does not affect the material composition and/or the jointing compound's ability to allow water vapor to pass through it.

Preferably, material compositions in accordance with some embodiments are used to make a jointing compound with low shrinkage and high adhesion to the substrate. In some embodiments, these material compositions have excellent hydrophobic properties. For example, in some embodiments, amounts of one or more of the CSH, the CC powder, the hydrophobic dispersible polymer, and the retarder is varied to obtain a desired water absorption rate of the material composition. The water absorption rate corresponds to a ratio of a weight of water absorbed to a weight of the material composition in dry form. In some embodiments, the water absorption rate of the material composition is less than 5%. Further, a silane emulsion coating is applied on the surface of the material composition. The silane emulsion coating includes a solventless emulsion based on a mixture of silane and siloxane. In accordance with the present disclosure, the silane emulsion coating is formulated to reduce a capillary water absorption rate of the material composition. The capillary water absorption rate corresponds to a rate of water absorption into the material composition by capillary suction. Thus, due to its hydrophobic nature and the waterproof coating on the material composition and/or the resulting jointing compound, the composition, compound, or both are suitable for use in dry and wet interior areas, and for exterior areas of a building.

In some embodiments, the initial setting time of the material composition is prolonged by an amount of time, and the material composition loses its plasticity and becomes hard during the initial setting time (i.e., changes from a plastic state to a solid state). In some embodiments, the initial setting time of the material composition is between 45 and 60 minutes, though other setting times are also contemplated.

In some embodiments, the material composition sets rapidly by an amount of time during the final setting time, during which the material composition loses its plasticity by a predetermined amount (i.e., it changes from a plastic state to a solid state). In some embodiments, the final setting time of the material composition is around 4 hours.

Other properties of the present material composition may include, but are not limited to, a grain size of 75 μm or less and a dry bulk density of 600 kg/m³. The initial setting time of the material composition may be between 45 and 60 minutes, and the final setting time of the material composition may be around 4 hours.

Material compositions in accordance with some embodiments have many

applications in architecture, such as filling, smoothing, and finishing dry interior walls, concrete walls, block walls, brick walls, and ceilings. These compositions have low shrinkage and high adhesion to the substrate. They can be used to laminate gypsum board to gypsum board and as a repair material for minor scratches and dents. Further, these compositions can be used for dry and wet areas in interior areas of a building. Additionally, with the silane emulsion coating, they are is suitable for exterior areas of a building as well.

Further, the present material compositions may be made available in a prepackaged form, and water is added in an amount that may be sufficient to produce a jointing compound with a predetermined range of flowable consistency. In some embodiments, one package of the material composition weighs around 50 pounds (lbs). Typically, the shelf life of the material composition is about 6 months from the date of packaging, if stored properly, i.e., stored at an elevated place on the ground, away from moisture, and preferably at a temperature below 35° C. A person of ordinary skill in the art will understand that other configurations and scenarios are also possible for the composition in accordance with some embodiments.

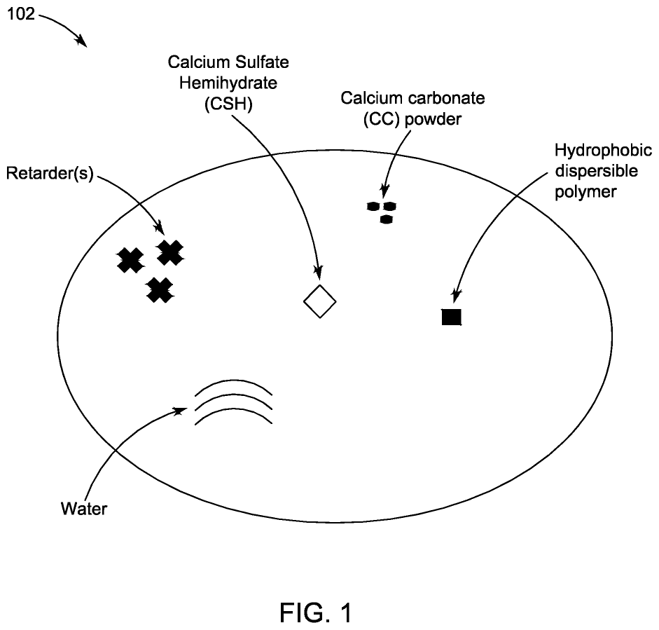

FIG. 1 illustrates ingredients collated in the form of a group 102 that make up an exemplary material composition, in accordance with some embodiments of the present disclosure. In some embodiments, the ingredients may include, but are not limited to, calcium sulfate hemihydrate (CSH), calcium carbonate (CC) powder, hydrophobic dispersible polymer(s), and retarder(s). Further, water may be added to the ingredients when making up the material composition. Thus, in some embodiments, the group 102 may be used to manufacture the exemplary material composition.

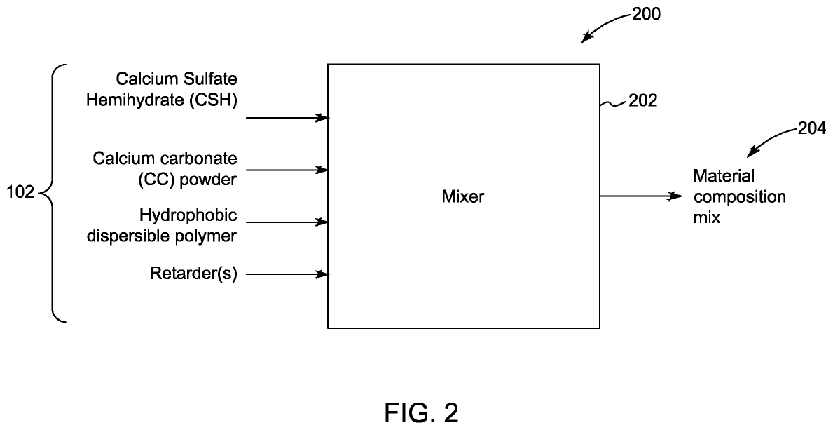

FIG. 2 illustrates an arrangement 200 for manufacturing material compositions, in accordance with some embodiments of the present disclosure.

The arrangement 200 includes a mixer 202 that receives as inputs ingredients 102 and produces a material composition mix 204. The ingredients 102 include calcium sulfate hemihydrate (CSH), calcium carbonate (CC) powder, hydrophobic dispersible polymer(s), and retarder(s). In some embodiments, the retarder includes poly condensed amino acid, and the hydrophobic dispersible polymer includes a flexible terpolymer of vinyl chloride, ethylene, and vinyl laurate. In some embodiments, all these components 102 are added in the mixer 202 with water in appropriate quantities according to the desired material composition. The table below (Table 1) indicates the appropriate quantities of the components of the material composition in accordance with some embodiments. The quantities indicated in Table 1 are non-limiting. Other ingredients and quantities are contemplated.

TABLE 1

| | Quantity |
|---|---|
| | (Percentage of material |
| Component | composition by weight) |
| Calcium sulfate hemihydrate (CSH) | 50%-80% |
| Calcium carbonate (CC) powder | 20%-50% |
| Hydrophobic dispersible polymer | 2%-3% |
| Retarder | 0.01%-0.011% |

A person of ordinary skill in the art will understand that a mixer blends and mixes materials to produce a resulting mix. In some embodiments, the mixer 202 includes, but is not limited to, batch mixers, such as drum type mixers and pan type mixers, and continuous mixers, which may be used for the present disclosure. A person of ordinary skill in the art will understand that other configurations are also possible for the mixer 202.

Referring to FIG. 2, once the components 102 are mixed in the mixer 202 at a predetermined speed for a predetermined amount of time, a consistent and workable material composition mix, that is, a jointing compound 204 (with a predetermined range of flowable consistency) is obtained. This consistent and workable material composition 204 may be used for various purposes such as, but not limited to, gypsum board joint filler, interior and exterior ceilings coating, gypsum board lamination, dry and wet interior coating, exterior coating, and a skim coat for concrete, block, and brick wall substrates, to name only a few examples.

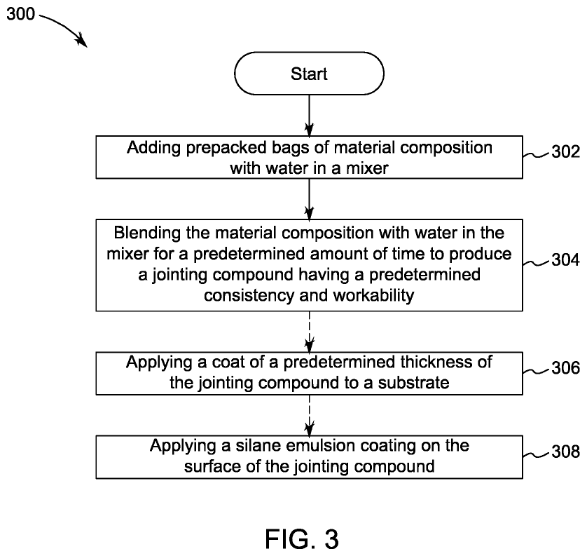

FIG. 3 illustrates a flowchart specifying the steps of a method 300 for manufacturing material compositions for construction activities, in accordance with some embodiments of the present disclosure, such as in architectural applications. The material composition described herein may be equivalent to the material composition 204 of FIG. 2 in its functionality and characteristics, as described above.

Although specific operations are disclosed herein, such operations are examples and are non-limiting. In different embodiments, to name only a few examples, the method 300 includes other steps, the sequence of the steps is modified, some steps are omitted, or any combination of these variations may be incorporated. The steps of the method 300 may be automated or semi-automated. In various embodiments, one or more of the operations of the method 300 may be controlled or managed by software, by firmware, by hardware, or by any combination thereof, but is not limited to such.

In some embodiments, the method 300 includes processes in accordance with the present disclosure which may be controlled or managed by a processor(s) and electrical components under the control of a computer or computing device comprising computer-readable media containing non-transitory computer-executable instructions or code that when executed by the processor(s) perform the steps of the method 300. The readable and executable instructions (or code) may reside, for example, in data storage such as volatile memory, non-volatile memory, and/or mass data storage, as only some examples. In some embodiments, automation of the method 300 through a computer employs various peripherals such as sensors, robotic arms, etc.

Referring to FIG. 3, at a step 302, prepacked bags of material composition are added to water (for example, in a predetermined amount) in a mixer (for example, mixer 202 of FIG. 2). In some embodiments, the material composition includes calcium sulfate hemihydrate (CSH), calcium carbonate (CC) powder, hydrophobic dispersible polymer(s), and retarder(s). In some embodiments, the retarder includes poly condensed amino acid, and the hydrophobic dispersible polymer includes a flexible terpolymer of vinyl chloride, ethylene, and vinyl laurate.

Next, at a step 304, the material composition is blended with water in the mixer at a predetermined speed for a predetermined amount of time to produce a jointing compound having a predetermined consistency and workability. The predetermined amount of time and/or the predetermined speed may be based on a type and/or a size of the mixer and/or on the desired consistency of the mixture.

Next, the method 300 includes steps of using the material composition, depicted as optional steps 306 and 308. At step 306, a coat of a predetermine thickness of the material composition and/or the jointing compound is applied onto a substrate. The substrate could refer to, gypsum boards, concrete, block, and brick walls, as a few examples. For application of the material composition on a surface, such as a wall, a ceiling, or a drywall, for best results the surface should be prepared before applying the material composition. For example, the surface should be clean, smooth, dry, and free from any loose materials, grease and oil. The surface should be inspected, and any uneven areas should be repaired, patched, and leveled. Next, a thin coat of the material and/or the jointing compound should be applied onto the surface and/or the substrate to obtain good adhesion using the smooth side of a trowel. In some embodiments, the total thickness of the coating is less than or equal to 5 mm.

At step 308, in case of application on exterior areas of a building, a silane emulsion coating is applied on the surface of the jointing compound. In an embodiment, the silane emulsion coating includes a solventless emulsion based on a mixture of silane and siloxane. The silane emulsion may be formulated by mixing water re-dispersible silicone-based water repellent powder with water in a ratio between 1:4 and 1:9 before application. Next, the silane emulsion mixture may be applied on the surface of the material composition, preferably by spraying or brushing. Further, preferably, two wet-on-wet coats of the silane emulsion are recommended to ensure complete coverage and desired water repellence.

Further, in some embodiments, as is commonly known the art, sanding the substrate, such as a drywall, after the jointing compound dries creates a smooth and even surface. Sanding of the surface may be done in preparation for the application of a primer and/or paint. Generally, the process of sanding a jointing compound creates a substantial amount of dust, which may cause several health risks for the construction workers. For example, breathing the dust from drywall jointing compounds may cause a persistent cough, throat irritation, and difficulty breathing. Over time, exposure to these compounds may result in higher risk health problems, such as sinus or asthma. However, the disclosed material composition eliminates the above-mentioned risks to a substantial degree. Preferably, material compositions, in accordance with the disclosed embodiments generate nearly zero dust during the sanding process. The hydrophobic dispersible polymer in the material composition binds all ingredients of the material composition and improves the bonding of interfaces of the ingredients. Thus, there is a significant dust reduction when the disclosed jointing compound is sanded.

Embodiments of the material composition and the methods of making and using them provide a versatile, economical, and environmentally friendly architectural product. Mixes of material compositions in accordance with some embodiments do not contain cement or any cementitious binder, and, thus are green materials. Material compositions have been specially formulated to have hydrophobic properties. Hence, these compositions can be used in dry and wet areas of a building. Another advantage of the material compositions is that they can be used in exterior areas of a building as well with an application of a silane emulsion coating. Further, the material compositions and/or the resulting jointing compounds generate minimal dust during the sanding process. They both reduce the risk of construction workers' eye, skin, nose, and respiratory irritation. These and other like advantages make the disclosed embodiments a multifunctional and improved jointing compound.

In some embodiments, a system (in an example, a computer) for performing the steps of method 300 is automated. Preferably, the computer may comprise a memory storing computer-executable instructions that when executed by a processor(s) perform the steps of method 300.

The terms “comprising,” “including,” and “having,” as used in the disclosure herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the disclosure. The term “connecting” includes connecting, either directly or indirectly, and “coupling,” including through intermediate elements.

The disclosure has been described with reference to various specific and preferred embodiments and techniques. However, it should be understood that many variations and modifications may be made while remaining within the spirit and scope of the disclosure. It will be apparent to one of ordinary skill in the art that methods, devices, device elements, materials, procedures, and techniques other than those specifically described herein can be applied to the practice of the disclosure as broadly disclosed herein without resort to undue experimentation. All art-known functional equivalents of methods, devices, device elements, materials, procedures, and techniques described herein are intended to be encompassed by this disclosure. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the building blocks described herein contain optional features that can be individually or together applied to any other embodiment shown or contemplated here to be mixed and matched with the features of that building block.

While the disclosure has been described with respect to a limited number of embodiments, those skilled in the art, having benefit of this disclosure, will appreciate that other embodiments can be devised which do not depart from the spirit and scope of the disclosure as disclosed herein.

We claim:

1. A material composition for use in construction, comprising:
calcium sulfate hemihydrate (CSH);
calcium carbonate (CC) powder;
a hydrophobic dispersible polymer; and
a retarder comprising modified amino acid.

2. The material composition of claim 1, wherein the hydrophobic dispersible polymer is based on a flexible terpolymer of vinyl chloride, ethylene, and vinyl laurate.

3. The material composition of claim 1, wherein amounts of one or more of: the CSH, the CC powder, the hydrophobic dispersible polymer, and the retarder correspond to a water absorption rate of the material composition, and wherein the water absorption rate corresponds to a ratio of a weight of water absorbed to a weight of the material composition in dry form.

4. The material composition of claim 3, wherein the water absorption rate of the material composition is less than 5%.

5. The material composition of claim 1, further comprising a silane emulsion coating for application on the surface of the material composition, wherein the silane emulsion coating includes a solventless emulsion based on a mixture of silane and siloxane.

6. The material composition of claim 5, wherein the silane emulsion coating is formulated to reduce a capillary water absorption rate of the material composition, and wherein the capillary water absorption rate corresponds to a rate of water absorption into the material composition by capillary suction.

7. The material composition of claim 5, wherein the silane emulsion coating includes a water re-dispersible silicone-based water repellent powder mixed with water in a ratio between 1:4 and 1:9.

8. The material composition of claim 1, wherein a grain size of the material composition is 75 um or less.

9. The material composition of claim 1, further comprising water in an amount such that a flowable consistency of the material composition is within a predetermined range.

10. The material composition of claim 1, wherein the material composition is cement-free.

11. The material composition of claim 1, wherein the material composition forms one or more of: gypsum board joint filler, interior and exterior ceilings coating, gypsum board lamination, dry and wet interior coating, exterior coating, and a skim coat for concrete, block, and brick wall substrates.

12. The material composition of claim 1, wherein:
a quantity of the CSH is between 50%-80% of the material composition by weight;
a quantity of the CC powder is between 20%-50% of the material composition by weight;
a quantity of the hydrophobic dispersible polymer is between 2%-3% of the material composition by weight; and
a quantity of the retarder is between 0.01%-0.011% of the material composition by weight.

13. A method of using material composition in one or more construction activities, the method comprising:
adding the material composition to water in a mixer, wherein the material composition comprises calcium sulfate hemihydrate (CSH), calcium carbonate (CC) powder, a hydrophobic dispersible polymer, and a retarder comprising modified amino acid; and
blending the material composition with water in the mixer for a predetermined amount of time to produce a jointing compound having a predetermined consistency and workability.

14. The method of claim 13, further comprising applying a coat of a predetermined thickness of the jointing compound to a substrate.

15. The method of claim 14, wherein the predetermined thickness is 5 mm or less.

16. The method of claim 13, further comprising applying a silane emulsion coating on a surface of the jointing compound, wherein the silane emulsion coating includes a solventless emulsion based on a mixture of silane and siloxane.

17. The method of claim 16, wherein applying the silane emulsion coating includes mixing a water re-dispersible silicone-based water repellent powder with water in a ratio between 1:4 and 1:9.

18. The method of claim 13, wherein amounts of one or more of: the CSH, the CC powder, the hydrophobic dispersible polymer, and the retarder correspond to a water absorption rate of the material composition, and wherein the water absorption rate corresponds to a ratio of a weight of water absorbed to a weight of the material composition in dry form.

19. The method composition of claim 18, wherein the water absorption rate of the material composition is less than 5%.

20. The method of claim 13, wherein the material composition comprises:
a quantity of the CSH is between 50%-80% of the material composition by weight;
a quantity of the CC powder is between 20%-50% of the material composition by weight;
a quantity of the hydrophobic dispersible polymer is between 2%-3% of the material composition by weight; and
a quantity of the retarder is between 0.01%-0.011% of the material composition by weight.
